(19) United States
(12) Patent Application Publication
(10) Pub. No.: US 2026/0057009 A1
(43) Pub. Date: Feb. 26, 2026

(54) ELECTRONIC DEVICE AND METHOD FOR IMAGE EDITING IN THE SAME

(71) Applicant: Samsung Electronics Co., Ltd., Suwon-si (KR)

(72) Inventors: Donghyun LEE, Suwon-si (KR); Gun LIM, Suwon-si (KR); Taehwan KA, Suwon-si (KR); Yang SHI, Suwon-si (KR); Yongkyun CHOI, Suwon-si (KR)

(21) Appl. No.: 19/352,909

(22) Filed: Oct. 8, 2025

Related U.S. Application Data
(63) Continuation of application No. PCT/KR2025/012566, filed on Aug. 19, 2025.

(30) Foreign Application Priority Data
Aug. 20, 2024 (KR) 10-2024-0111474
Oct. 7, 2024 (KR) 10-2024-0136033

(51) Int. Cl. G06F 16/538; G06F 16/51; G06F 16/535; G06T 1/00; G06V 10/22; G06V 10/764

(52) U.S. Cl. CPC G06F 16/538; G06F 16/51; G06F 16/535; G06T 1/0007; G06V 10/235; G06V 10/764

(57) ABSTRACT

An electronic device is provided. The electronic device includes memory storing instructions and including one or more storage media and at least one processor including processing circuitry, the at least one processor communicatively coupled to the memory, wherein the instructions, when individually or collectively executed by the at least one processor, cause the electronic device to activate a search function comprising a circle-to-search function, based on a configuration of the electronic device, after the search function is activated, determine an area in which an object is to be recognized, based on a user input for a display, recognize an object displayed within the determined area, display the recognized object in a first area of the display, display a search result of the recognized object in a second area of the display, and store an image of the recognized object and information on the search result of the recognized object in a predetermined space of the memory, and wherein the circle-to-search function includes a function of designating a specific area in the display, based on an input of a user, and performing a search for an image of the predetermined area.

### CROSS-REFERENCE TO RELATED APPLICATION(S)

This application is a continuation application, claiming priority under 35 U.S.C. § 365 (c), of an International application No. PCT/KR2025/012566, filed on Aug. 19, 2025, which is based on and claims the benefit of a Korean patent application number 10-2024-0111474, filed on Aug. 20, 2024, in the Korean Intellectual Property Office, and of a Korean patent application number 10-2024-0136033, filed on Oct. 7, 2024, in the Korean Intellectual Property Office, the disclosure of each of which is incorporated by reference herein in its entirety.

### TECHNICAL FIELD

The disclosure relates to an electronic device and a technique for improving an image search function. More particularly, the disclosure relates to a method for image editing, which automatically saves an image searched for by expanding a circle-to-search function and allows a user to conveniently manage the image.

### BACKGROUND ART

The circle-to-search function may refer to a function that allows a user to perform a search by specifying a specific area on a display. However, this function currently only shows a search result temporarily, and the search record disappears unless the user saves the result separately. This can make it difficult for a user to re-search the image having been searched for in the past or to find additional related information.

The above information is presented as background information only to assist with an understanding of the disclosure. No determination has been made, and no assertion is made, as to whether any of the above might be applicable as prior art with regard to the disclosure.

### DISCLOSURE OF INVENTION

Aspects of the disclosure are to address at least the above-mentioned problems and/or disadvantages and to provide at least the advantages described below. Accordingly, an aspect of the disclosure is to provide an electronic device for automatically saving images searched for through a circle-to-search function into a gallery app, and thus providing a technology that enables a user to easily identify and manage the images later.

Another aspect of the disclosure is to provide a circle-to-search function for an efficient way to manage a storage space of images searched for.

In accordance with an aspect of the disclosure, an electronic device is provided. The electronic device includes memory storing instructions and including one or more storage media and at least one processor including processing circuitry, the at least one processor communicatively coupled to the memory, wherein the instructions, when individually or collectively executed by the at least one processor, cause the electronic device to activate a search function including a circle-to-search function, based on a configuration of the electronic device, after the search function is activated, determine an area in which an object is to be recognized, based on a user input for a display, recognize an object displayed within the determined area, display the recognized object in a first area of the display, display a search result of the recognized object in a second area of the display, and store an image of the recognized object and information on the search result of the recognized object in a predetermined space of the memory, and wherein the circle-to-search function includes a function of designating a specific area in the display, based on an input of a user, and performing a search for an image of the determined area.

In accordance with another aspect of the disclosure, a method performed by an electronic device is provided. The method includes activating a search function comprising a circle-to-search function, based on a configuration of the electronic device, after the search function is activated, determining an area in which an object is to be recognized, based on a user input for a display, recognizing an object displayed within the determined area and displaying the recognized object in a first area of the display, displaying a search result of the recognized object in a second area of the display, and storing an image of the recognized object and/or information on the search result of the recognized object in a predetermined space of memory of the electronic device, wherein the circle-to-search function comprises a function of designating a specific area in the display, based on an input of a user, and performing a search for an image in the determined area.

In accordance with yet another aspect of the disclosure, a computer-readable non-transitory storage medium configured to store one or more programs comprising instructions is provided. The programs include instructions that, when executed by the at least one processor of the electronic device individually or collectively, cause the electronic device to activate a search function comprising a circle-to-search function, based on a configuration of the electronic device, after the search function is activated, determine an area in which an object is to be recognized, based on a user input for a display, recognize an object displayed within the determined area, display the recognized object in a first area of the display, display a search result of the recognized object in a second area of the display, and store an image of the recognized object and/or information on the search result of the recognized object in a predetermined space of memory of the electronic device, wherein the circle-to-search function comprises a function of designating a specific area in the display, based on a user input, and performing a search for an image in the determined area.

The electronic device according to the disclosure can allow a user to easily find and manage an image searched by the user, thereby enhancing the user experience.

The electronic device according to the disclosure can provide additional information about the image searched for, thereby effectively helping a user quickly obtain the information that the user wants. In addition, related additional information can be identified through attribute information and a storage space of the image searched for can be efficiently managed.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 illustrates a process of executing a circle-to-search function in an electronic device according to an embodiment of the disclosure;

FIG. 3 illustrates a search record according to execution of a circle-to-search function in an electronic device according to an embodiment of the disclosure;

FIG. 4 illustrates a process of executing a circle-to-search function and editing an image selected by a user in an electronic device according to an embodiment of the disclosure;

FIG. 5 illustrates a process of executing a circle-to-search function and storing an image selected by a user in an electronic device according to an embodiment of the disclosure;

FIG. 6 illustrates pieces of information stored during a process of executing a circle-to-search function in an electronic device according to an embodiment of the disclosure;

FIG. 7A illustrates a screen searched by executing a circle-to-search function in an electronic device according to an embodiment of the disclosure;

FIG. 7B illustrates stored images when a circle-to-search function is executed in an electronic device according to an embodiment of the disclosure;

FIG. 8A illustrates stored images displayed in a story format when a circle-to-search function is executed in an electronic device according to an embodiment of the disclosure;

FIG. 8B illustrates a screen where images stored when a circle-to-search function has been executed are classified by topic in an electronic device according to an embodiment of the disclosure;

FIG. 9 is a flowchart illustrating an image editing method of an electronic device according to an embodiment of the disclosure;

FIG. 10 is a flowchart illustrating an embodiment of an image editing method of an electronic device according to an embodiment of the disclosure; and

FIG. 11 illustrates an image editing method of an electronic device by function according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

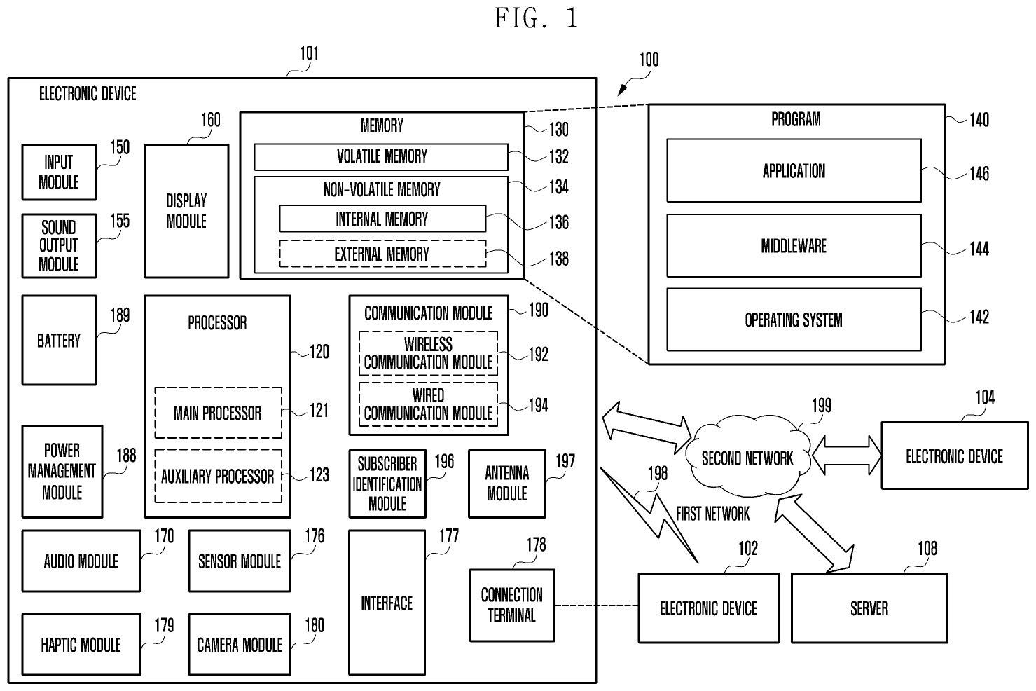

FIG. 1 is a block diagram illustrating an electronic device 101 in a network environment 100 according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave band)) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104 or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it connotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply connotes that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

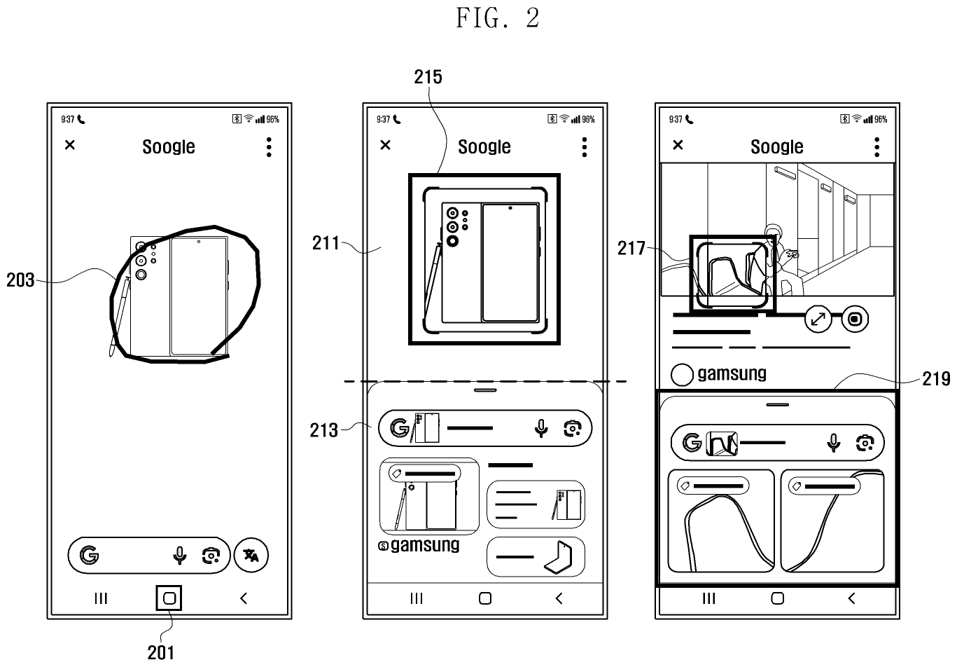

FIG. 2 illustrates a process of executing a circle-to-search function in an electronic device according to an embodiment of the disclosure.

An electronic device (e.g., the electronic device 101 of FIG. 1) may detect a user input (e.g., a long touch input) to a specific button (e.g., a home button) 201 on a display and activate a circle-to-search function. The electronic device 101 may provide an effect of allowing a user to quickly search for a specific object on a screen by using the circle-to-search function. For example, the electronic device 101 may display a search result for a specific object when a user input (e.g., drawing a circle with a finger or a stylus pen) 203 is detected over a specific picture or text on a display screen. The electronic device 101 may easily provide a user with the information wanted by the user by using the circle-to-search function.

The electronic device 101 may detect a user input for an object to be searched and activate a circle-to-search function. The electronic device 101 may display an image of an object selected by the user input on an upper display part 211 (e.g., a first area). The electronic device 101 may display an Internet search result for the selected object in a lower display part 213 (e.g., second area). The image of the object is shown on the upper display part 211, and the Internet search result is shown on the lower display part 213, but the positions are not fixed.

The electronic device 101 may detect an input in a predetermined area 215 and may perform a circle-to-search function. The electronic device 101 may recognize a smartphone in the predetermined area 215 and may display a search result for the smartphone in the lower display part 213. The search result may refer to, for example, a search result from a search engine such as Google. The electronic device 101 may detect a chair in an area 217 selected by the user and may display a search result 219 of similar products found on the Internet.

A user may scroll through a search result and select information the user want. For example, if you see a sign for a specific restaurant and want to know the menu or reviews, you may draw a circle around the sign and check the search result below. The electronic device 101 may provide related information to the user using the circle-to-search function. Or, if you are watching a television (TV) program and you want to know the name of an actor who has appeared, you may draw a circle around that actor's face and immediately search for related information. For example, if you are watching a video and want to know about a specific chair but the brand thereof is not tagged, you may use the circle-to-search function to immediately identify the search result for similar products on the web. In this way, a user may easily find the information the user want and may receive assistance in shopping or searching for information.

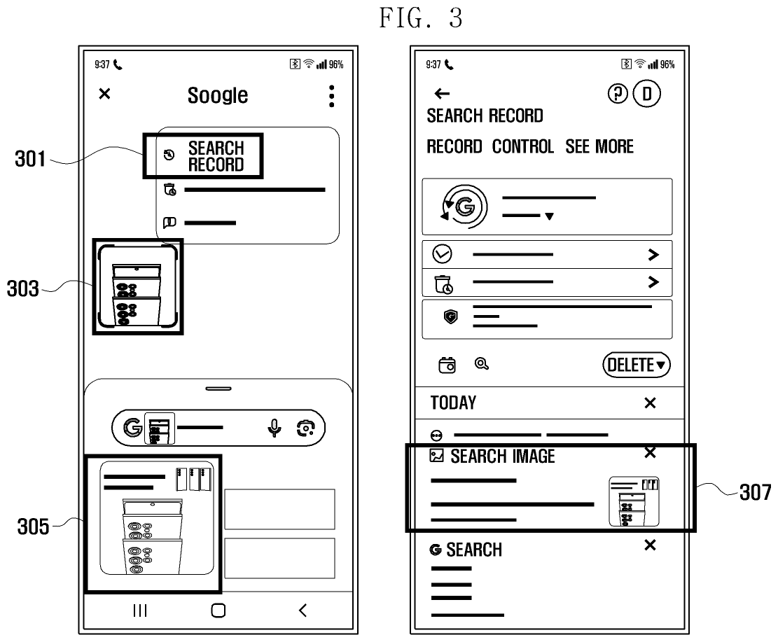

FIG. 3 illustrates a search record according to execution of a circle-to-search function in an electronic device according to an embodiment of the disclosure.

The circle-to-search function may provide a user with an effective way to search easily and quickly. For example, if a user draws a circle around a specific word on the user's smartphone screen, a search result for that word will appear at the bottom of the screen.

However, there is a drawback in that when a user presses a back button, the image searched for and the result screen immediately disappear. For example, if the user presses the back button after identifying the search result, the content the user previously searched for may disappear.

The function is useful for quick and easy one-time searches, but the images the user select with a circle are not saved separately. For example, when the user searches by drawing a circle around the image of a specific product, the image is not saved and only the search result is displayed.

Referring to FIG. 3, the electronic device 101 may detect a user input for a search record 301 and display the search record. The electronic device 101 may display the user's search history based on the user's input for the search record 301, but may also store the record of the sites accessed by clicking on an image in the search result. If the user accesses a website by clicking on an Internet search result image 305, only the website visit record 307 may be saved. That is, the electronic device 101 may have difficulty in storing an image 303 of an object displayed in an area selected by the user. When the user searches by drawing a circle around a specific object (e.g. a smartphone), only search result for that object may be displayed, and the image of that object may not be saved.

Accordingly, if a user does not remember what the user has searched by using the circle-to-search function, it may be difficult to check the image history or related information they searched for. For example, if a user want to find an image of a specific product that the user previously searched for, the user may click on the image to search the record of the sites the user visited because the user did not save the image. Because it is more difficult, than an image, to intuitively identify the record of sites accessed by clicking on the image, it may be difficult for the user to find the record of the user's searches again.

An electronic device according to the disclosure (e.g., the electronic device 101 of FIG. 1) may create a separate folder to store images used in a circle-to-search function to help find search records related to the circle-to-search function. Additionally, the electronic device 101 according to the disclosure may provide a function of storing the search result obtained at the time point at which a circle-to-search function was used and comparing the stored search result with the current search result.

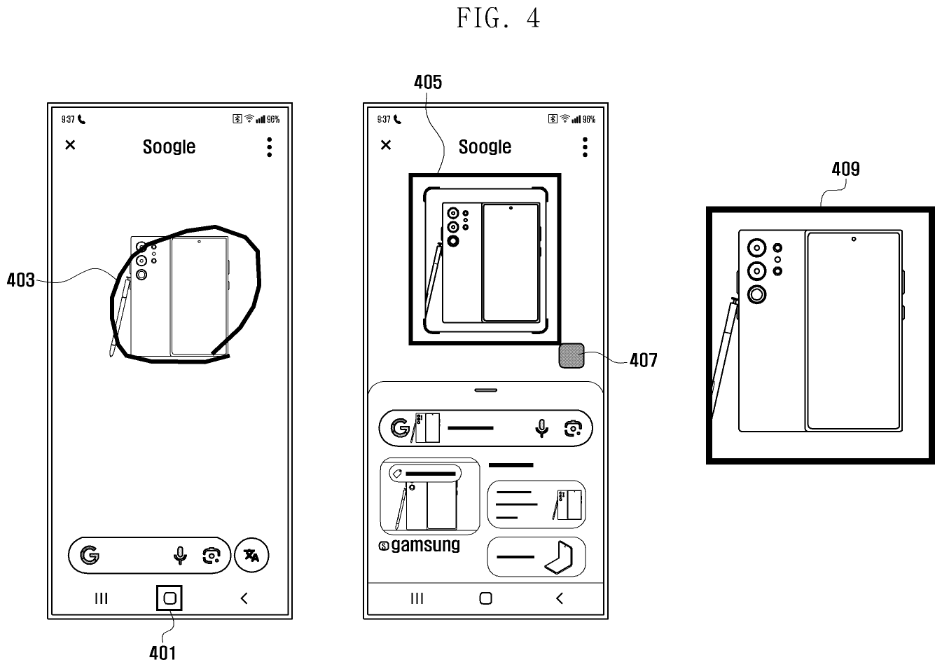

FIG. 4 illustrates a process of executing a circle-to-search function and editing an image selected by a user in an electronic device according to an embodiment of the disclosure.

An electronic device (e.g., the electronic device 101 of FIG. 1) may activate (turn on) a circle-to-search function in a configuration screen.

In a state where the circle-to-search function is activated, the electronic device 101 may detect a user input (e.g., a long touch input) to a specific button (e.g., a home button) 401 on the display and execute the circle-to-search function. In case that the circle-to-search function is determined not to work during the setup phase, the electronic device 101 may not execute the circle-to-search function even if the electronic device detects a user input (e.g., a long touch input) to a specific button (e.g., a home button) 401 on the display.

The electronic device 101 may determine an area 405 where a circle-to-search function is to be performed, based on a user input (e.g., a touch input using a finger, a user input using a pen) 403 to a display.

The electronic device 101 may determine an area 405 where a circle-to-search function is to be performed, based on a user input 403 to the display, and may recognize an object within the area 405 where a circle-to-search function is to be performed. The electronic device 101 may display a web search result for a recognized object at a lower part of a display. The electronic device 101 may display an interface 407 capable of capturing an image in an area in which an object to be recognized exists (or an image of a recognized object) and an image of a web search result. The interface 407 may be in the form of a button displayed on a display, for example. The electronic device 101 may capture an image displayed on the display based on a user input for the interface 407 and may determine the captured image as an image related to a circle-to-search function.

Alternatively, the electronic device 101 may determine that a captured image is an image related to a circle-to-search function, based on that a capture function is performed within a predetermined time (e.g., 10 seconds) after the circle-to-search function is performed. The electronic device 101 may store the image related to the circle-to-search function in a separate folder in memory (e.g., the memory 130 of FIG. 1). The electronic device 101 may create a folder for separately storing an image 409 related to the circle-to-search function, thereby providing convenience to the user when searching for an image related to the circle-to-search function.

According to an embodiment, the electronic device 101 may automatically store an image related to the circle-to-search function without a separate user input. The electronic device 101 may automatically store an image 409 related to a circle-to-search function when the circle-to-search function is executed through configuration. Alternatively, even if the circle-to-search function is executed through the configuration, the electronic device 101 may not automatically save the image 409 related to the circle-to-search function, and may store the image 409 related to the circle-to-search function in the memory 130 only when a user input (e.g., a touch input for the interface 407) is detected.

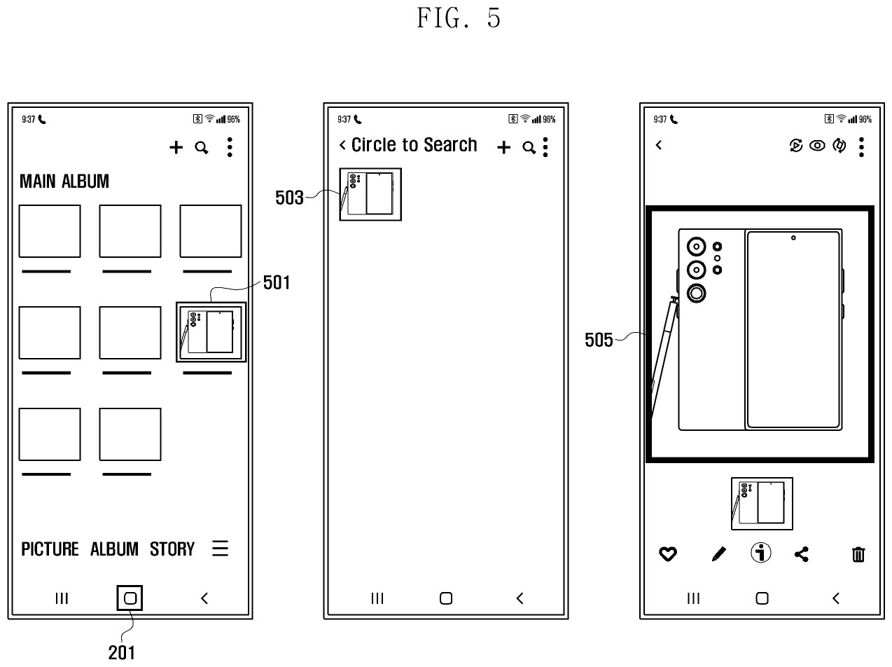

FIG. 5 illustrates a process of executing a circle-to-search function and storing an image selected by a user in an electronic device according to an embodiment of the disclosure.

According to an embodiment, an electronic device (e.g., the electronic device 101 of FIG. 1) may display a list of albums in a gallery configured to store an image or a video. The electronic device 101 may create a folder 501 to store images related to the circle-to-search function and may display the images in the gallery. The electronic device 101 may display a list of images related to the circle-to-search function, based on a user input for the folder 501 which stores the images related to the circle-to-search function. The electronic device 101 may display an enlarged image 505 based on that a specific image 503 is selected from a list of the images related to the circle-to-search function. The electronic device 101 may display an image selected by a user input when the circle-to-search function is executed, thereby providing the image so that the user may easily identify the object searched for by the user input. In addition, the electronic device 101 may provide a search result or accessed web address information related to the image while displaying the enlarged image 505, thereby improving user experience.

According to an embodiment, the electronic device 101 may store an image related to the circle-to-search function (e.g., image 409 related to the circle-to-search function of FIG. 4) in a separate folder. The electronic device 101 may create a separate folder when the circle-to-search function is first executed and may store an image 409 related to the circle-to-search function in the created folder. Afterwards, the electronic device 101 may automatically store related images in the created folder when the circle-to-search function is executed. The electronic device 101 may provide a function for a user to identify an image related to the circle-to-search function by using a separately created folder related to the circle-to-search function.

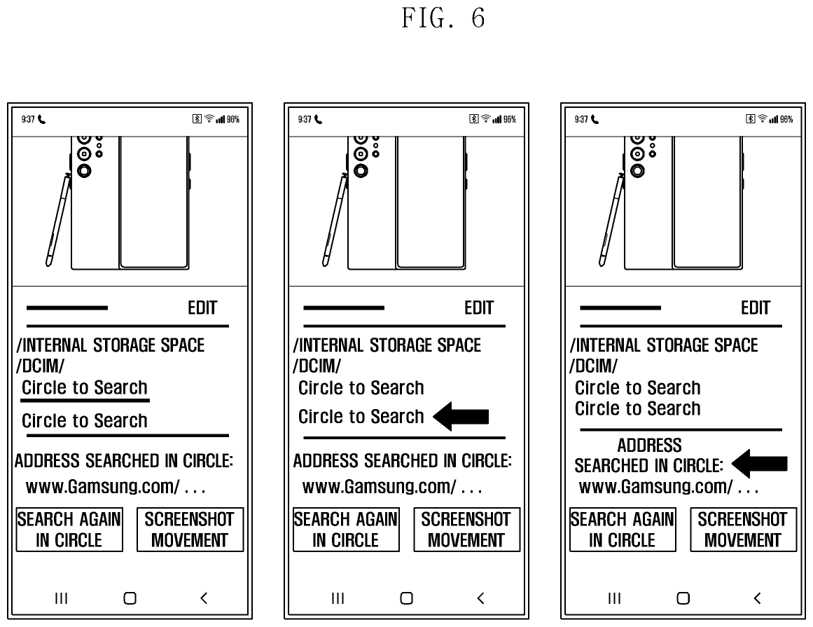

FIG. 6 illustrates pieces of information stored during a process of executing a circle-to-search function in an electronic device according to an embodiment of the disclosure.

According to an embodiment, an electronic device (e.g., the electronic device 101 of FIG. 1) may display an image related to a circle-to-search function, and may provide at least one of the time at which the image was stored, whether the image is relevant to the circle-to-search function, or the web address accessed at the time of the search. The electronic device 101 may connect to the web address accessed at the time of the search based on the user input regarding the web address accessed at the time of the search.

According to an embodiment, the electronic device 101 may display a storage path of an image and display information that the stored image is an image created through a circle-to-search function. The electronic device 101 may display a link to a web address accessed by the user among the web addresses displayed in the search result when the circle-to-search function is executed. The electronic device 101 may link to a website based on a user input for a web address link.

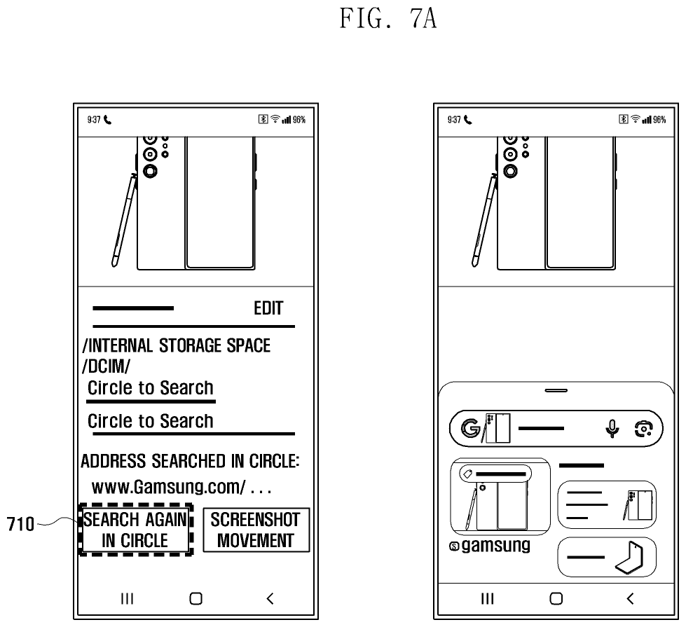

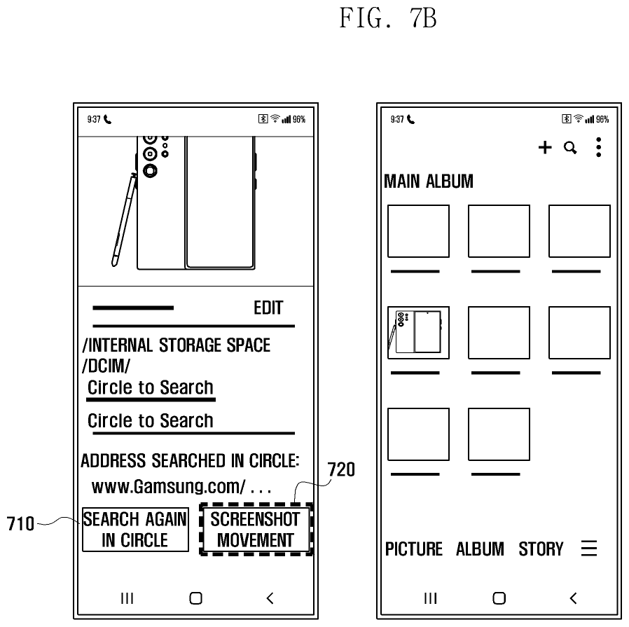

FIG. 7A illustrates a screen searched by executing a circle-to-search function in an electronic device according to an embodiment of the disclosure.

According to an embodiment, an electronic device (e.g., the electronic device 101 of FIG. 1) may display an image related to a circle-to-search function and display a first interface 710 that enables a web search to be performed again for the image related to the circle-to-search function. The first interface 710 may be displayed, for example, as a button called “Search again in circle”. The type of the first interface 710 is only an example and is not limited to the button form.

According to an embodiment, the electronic device 101 may display a search result for an object within an image related to a circle-to-search function based on a user input for the first interface 710. The electronic device 101 may execute the circle-to-search function without receiving a user input (e.g., a touch input using a finger, a touch input using a pen) for a part to be searched (e.g., the user input 403 of FIG. 4). The electronic device 101 may provide a user with the convenience of identifying images related to the circle-to-search function at once. In addition, the electronic device 101 may provide the user with the convenience of being able to identify a search result again only by the input for the first interface 710.

The electronic device 101 may display an image related to the circle-to-search function based on a user input for the first interface 710 to the display, and may display a search result for the object within the image related to the circle-to-search function.

FIG. 7B illustrates stored images when a circle-to-search function is executed in an electronic device according to an embodiment of the disclosure.

According to an embodiment, an electronic device (e.g., the electronic device 101 of FIG. 1) may display a second interface 720 that enables a user to identify the previous search result for a recognized object. For example, the second interface 720 may be displayed as a button called “Screenshot movement”. The type of the second interface 720 is only an example and is not limited to the button form.

The electronic device 101 may display an image of a search result obtained at a time point at which the image of a recognized object was stored in memory (e.g., the memory 130 of FIG. 1) based on a user input for the second interface 720.

The electronic device 101 may display at least one of information about when an image of a recognized object was stored in the memory 130, information about the location where the image was stored, or information about a link selected by the user from the displayed a search result.

The electronic device 101 may recognize an object by executing a circle-to-search function and display a search result for the recognized object. The search result may include, for example, information about the recognized object or the address of a web page related to the recognized object.

The electronic device 101 may store a web page displayed on the display as a screenshot based on a user input related to the execution of a screenshot capture function (e.g., simultaneously touching the side button and the home button of the electronic device 101, or swiping the display with the palm of the hand). The electronic device 101 may store a screenshot of a web page along with information indicating that the circle-to-search function has been executed. Additionally, the electronic device 101 may store an image of the recognized object along with the screenshot of the web page.

In an embodiment, the electronic device 101 may provide a search result screen obtained at a first time point at which the user executed the circle-to-search function based on a user input for the second interface 720. In addition, the electronic device 101 may provide a search result screen of a second time point (or current time point) based on a user input for the first interface (e.g., the first interface 710 of FIG. 7A). The first time point may refer to a time point that is earlier in time than the second time point. The second time point may refer to the present time point. The electronic device 101 may display the search result screen obtained at the first time point and the search result screen obtained at the second time point together to provide information on how the search result has changed. The electronic device 101 may provide the user with the latest search result by providing a search result screen obtained at a second time point (or the current time point). The electronic device 101 may provide the user with information about trend changes or price changes by comparing the search result from the first time point in the past with the search result from a second time point at present.

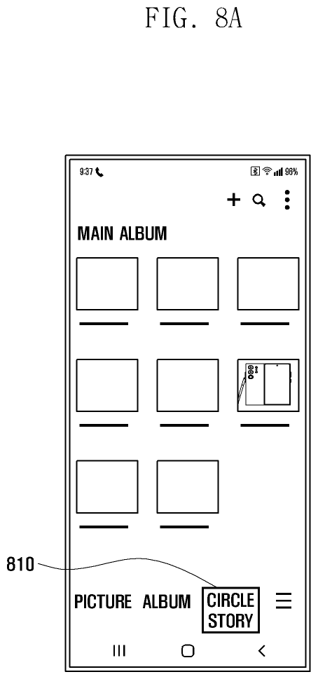

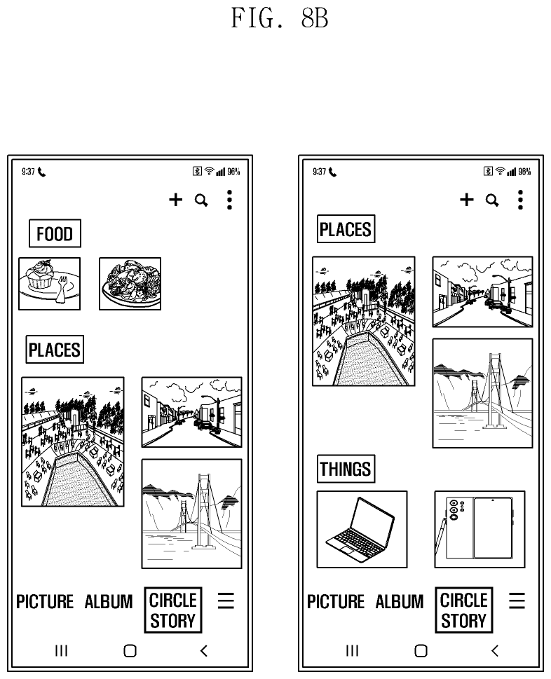

FIG. 8A illustrates stored images displayed in a story format when a circle-to-search function is executed in an electronic device according to an embodiment of the disclosure.

An electronic device (e.g., the electronic device 101 of FIG. 1) can display images in a folder where images related to a circle-to-search function are stored based on an input for an interface 810 related to a circle story. The electronic device 101 may classify stored images by topic within the folder in which images related to the circle-to-search function are stored. For example, the electronic device 101 may classify and display images that the user has searched by type of food, place, or object.

FIG. 8B illustrates a screen where images stored when a circle-to-search function has been executed are classified by topic in an electronic device according to an embodiment of the disclosure.

An electronic device (e.g., the electronic device 101 of FIG. 1) may classify images related to a circle-to-search function based on a topic (e.g., food, place, or object). The types of topics are just examples and are not limited thereto. In addition, images related to the circle-to-search function may be classified not only by subject but also by the time at which the images were stored.

In an embodiment, the electronic device 101 may provide an interface to enable a user to selectively delete images that have not been edited or searched by the user for a predetermined period (e.g., 30 days). The predetermined period (e.g. 30 days) may vary depending on the configuration.

Alternatively, for the images classified by topic, the electronic device 101 may retain images stored within a predetermined period (e.g., 30 days), and merge multiple images into a single image for images older than the predetermined period (e.g., 30 days) to reduce capacity. The electronic device 101 may retain images that are less than a predetermined period of time (e.g., 30 days) old from the time the images were stored, and merge multiple images into a single image to reduce capacity for images that are more than a predetermined period of time (e.g., 30 days) old from the time at which the images were stored. The electronic device 101 may classify images by topic and merge images classified by topic.

For example, the electronic device 101 may keep a first image and a second image, which were saved 7 days ago, in a folder within the gallery, and merge a third image, a fourth image, a fifth image, and a sixth image, which were saved more than 30 days ago, into one image. The third image and the fourth image may be related to food, and the fifth image and the sixth image may be related to places. The electronic device 101 may merge the third image and the fourth image, and may merge the fifth image and the sixth image. The electronic device 101 may keep only the merged images in the gallery and delete the rest of the images. The electronic device 101 may merge the first image and the second image into one image and delete the individual image, in case that the first image and the second image have been stored for more than 30 days. The predetermined period (e.g. 30 days) may vary depending on the configuration.

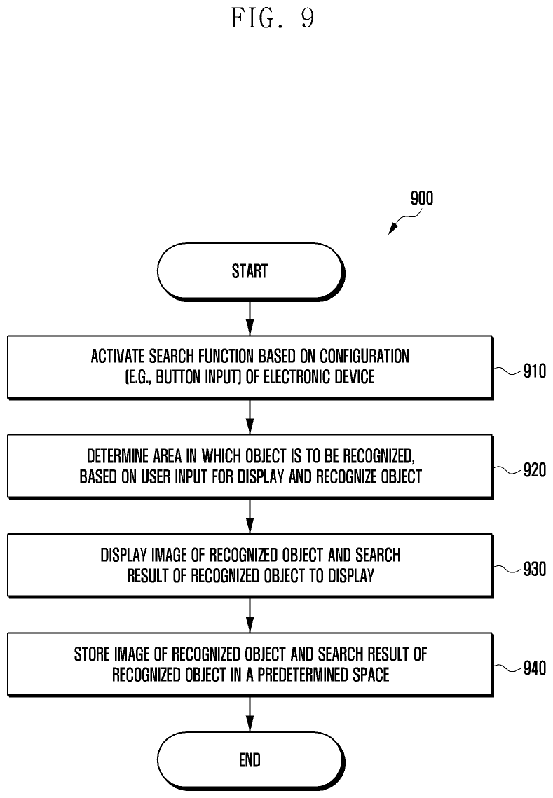

FIG. 9 is a flowchart illustrating an image editing method of an electronic device according to an embodiment of the disclosure.

The operations described through FIG. 9 may be implemented based on instructions that may be stored in a computer-readable recording medium or memory (e.g., the memory 130 of FIG. 1). The illustrated method 900 may be executed by an electronic device (e.g., the electronic device 101 of FIG. 1) described above through FIGS. 1 to 6, 7A, 7B, 8A, and 8B, and the technical features described above will be omitted below. The order of each operation in FIG. 9 may be changed, some operations may be omitted, and some operations may be performed simultaneously.

In operation 910, the electronic device 101 may activate a search function based on a configuration of the electronic device 101 (e.g., an input for a button) under the control of a processor (e.g., the processor 120 of FIG. 1). The search function may include a circle-to-search function. The circle-to-search function may refer to a function that allows a user to perform a search by specifying a specific area on the display.

In operation 920, the electronic device 101 may determine an area to recognize an object based on a user input for the display, and may recognize the object. The electronic device 101 may determine an area (e.g., the area 405 of FIG. 4) where a circle-to-search function is to be performed, based on a user input (e.g., a touch input using a finger, a touch input using a pen) (e.g., the user input 403 of FIG. 4) to the display.

In operation 930, the electronic device 101 may display an image of a recognized object and a search result for the recognized object on the display. The electronic device 101 may display an image of an object selected by a user input on the upper part of the display (e.g., the upper display part 211 of FIG. 2). The electronic device 101 may display an Internet search result for a selected object at the lower part of the display (e.g., the lower display part 213 of FIG. 2). It is explained that the image of the object is displayed on the upper display part 211, and the Internet search result is displayed on the lower display part 213, but the positions are not fixed.

In operation 940, the electronic device 101 may store an image of a recognized object and a search result for the recognized object in a designated space (e.g., a separate folder). The electronic device 101 may create a folder configured to separately store an image related to the circle-to-search function (e.g., the image 409 of FIG. 4), thereby providing convenience to the user when searching for an image related to the circle-to-search function. According to an embodiment, the electronic device 101 may automatically store the image related to the circle-to-search function without a separate user input. In case that the circle-to-search function is executed through a configuration, the electronic device 101 may automatically store the image 409 related to the circle-to-search function. Alternatively, even if the circle-to-search function is executed through the configuration, the electronic device 101 may not automatically save the image 409 related to the circle-to-search function, and may store the image 409 related to the circle-to-search function in the memory 130 only when a user input is detected. The user input may include, for example, a touch input for the interface 407 of FIG. 4. In an embodiment, an image of a recognized object and/or a search result for the recognized object may be stored in a database.

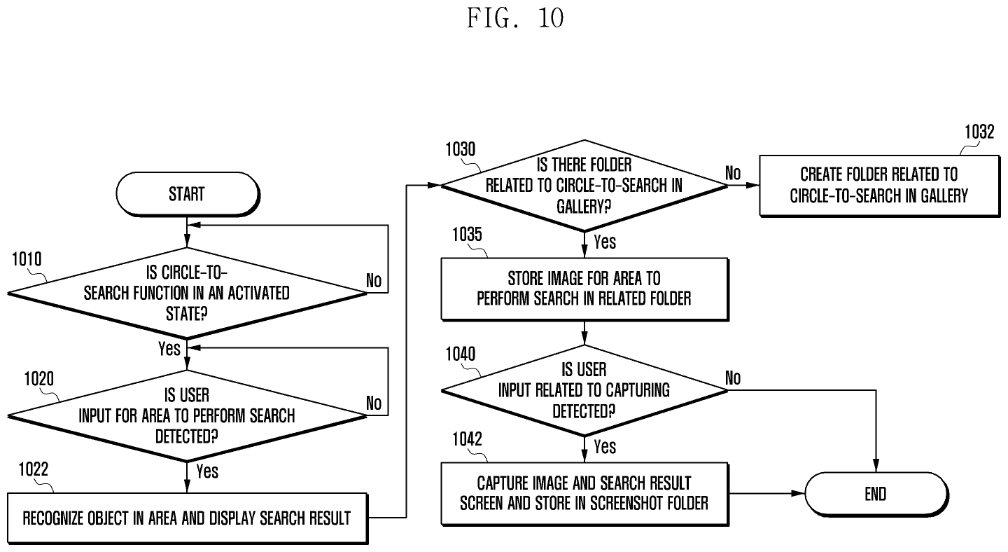

FIG. 10 is a flowchart illustrating an embodiment of an image editing method of an electronic device according to an embodiment of the disclosure.

The operations described through FIG. 10 may be implemented based on instructions that may be stored in a computer-readable recording medium or memory (e.g., the memory 130 of FIG. 1). The illustrated method may be executed by an electronic device (e.g., the electronic device 101 of FIG. 1) described above through FIGS. 1 to 6, 7A, 7B, 8A, and 8B, and the technical features described above will be omitted below. The order of each operation in FIG. 10 may be changed, some operations may be omitted, and some operations may be performed simultaneously.

In operation 1010, the electronic device 101 may determine, under the control of a processor (e.g., the processor 120 of FIG. 1), whether the circle-to-search function is in an activated state. The electronic device 101 may terminate operation in case that the circle-to-search function is not activated, or may identify again whether the circle-to-search function is activated.

In operation 1020, the electronic device 101 may detect a user input for an area to perform a search based on that the circle-to-search function is activated. The area to perform a search may refer to an area where the circle-to-search function will be executed. The user input may refer to, for example, a long touch input in a specific area on the display or an input using a stylus pen. If a specific area is selected by a user input, the electronic device 101 may determine to execute a circle-to-search function for the specific area.

The electronic device 101 may terminate the operation based on that the user input for the area to perform the search is not detected, or may re-identify whether a user input in the area to perform the search has been detected.

In operation 1022, the electronic device 101 may recognize an object within an area based on that the user input for the area to perform the search is detected, and may display a search result. The electronic device 101 may recognize an object, based on an image in an area determined to perform a circle-to-search function. The electronic device 101 may display an Internet search result for the recognized object. Alternatively, the electronic device 101 may search for an image in the determined area and may display the search result.

In operation 1030, the electronic device 101 can check whether a folder related to a circle-to-search function exists in the gallery. The electronic device 101 may create a folder (e.g., the folder 501 in FIG. 5) configured to store an image related to the circle-to-search function and may display the image in the gallery.

In operation 1032, the electronic device 101 may create a new folder related to a circle-to-search function based on that a folder related to the circle-to-search function does not exist in the gallery. The electronic device 101 may create a separate folder when the circle-to-search function is first executed and may store an image (e.g., the image 409 of FIG. 4) related to the circle-to-search function in the created folder. Afterwards, the electronic device 101 may automatically store related images to the created folder when the circle-to-search function is executed.

In operation 1035, the electronic device 101 may store an image in an area to perform a search in a related folder. The electronic device 101 may display a list of images related to the circle-to-search function based on a user input for a folder 501 configured to store images related to the circle-to-search function. The electronic device 101 may display an enlarged image 505 based on that a specific image 503 is selected from a list of images related to the circle-to-search function. The electronic device 101 may display an image selected by a user input when the circle-to-search function is executed, thereby providing a user with an easy way to identify the object searched for by the user. In addition, the electronic device 101 may provide a search result or accessed web address information related to the image while displaying an enlarged image 505, thereby improving user experience.

In operation 1040, the electronic device 101 may determine whether a user input related to capturing is detected. The electronic device 101 may display a web search result for a recognized object at the lower part of the display. The electronic device 101 may display an interface (e.g., the interface 407 of FIG. 4) capable of capturing an image of a recognized object and an image of a web search result. The interface 407 may be in the form of a button displayed on a display, for example.

In operation 1042, the electronic device 101 may capture an image and search result screen and may store the image and search result screen to the screenshot folder. The electronic device 101 may capture an image displayed on the display based on a user input for the interface 407 and determine the captured image as an image related to a circle-to-search function.

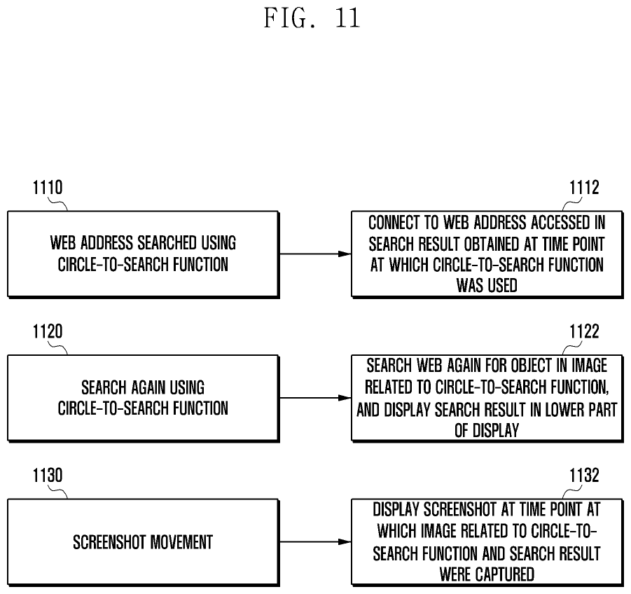

FIG. 11 illustrates an image editing method of an electronic device by function of the disclosure.

The operations described through FIG. 11 may be implemented based on instructions that may be stored in a computer-readable recording medium or memory (e.g., the memory 130 of FIG. 1). The illustrated method may be executed by an electronic device (e.g., the electronic device 101 of FIG. 1) described above through FIGS. 1 to 6, 7A, 7B, 8A, and 8B, and the technical features described above will be omitted below. The order of each operation in FIG. 11 may be changed and each operation may not necessarily be executed sequentially. Some operations in FIG. 11 may be omitted, and some operations may be performed simultaneously.

In operation 1110, the electronic device 101 may detect a user input for an interface corresponding to a “Web address searched using circle-to-search function”. In operation 1112, the electronic device 101 may connect to the web address accessed from the search result obtained at the time point at which the circle-to-search function was used.

In operation 1120, the electronic device 101 may detect a user input for an interface corresponding to “Search again using circle-to-search function”. In operation 1122, the electronic device 101 may search the web again for an object within the image related to the circle-to-search function and may display the search result at the lower part of the display. The electronic device 101 may provide a current search result screen based on a user input.

In operation 1130, the electronic device 101 may detect a user input for an interface corresponding to moving a screenshot. In operation 1132, the electronic device 101 may display a screenshot of the time point at which the image and search result related to the circle-to-search function were captured. The electronic device 101 may provide a search result screen obtained at the time point at which the user executed the circle-to-search function based on a user input.

According to an embodiment, the electronic device 101 may display the search result screen obtained at the time point at which the user executed the circle-to-search function and the current search result screen together to provide information on how the search result has changed. The electronic device 101 may provide a search result screen of the current time point to provide the user with the latest search result.

According to an embodiment, the electronic device 101 may automatically store an image of the recognized object in the memory when the circle-to-search function is executed, may display the image of the recognized object, and may display the time point at which the image for the recognized object was stored, the location at which it was stored, and whether the image was searched for via a circle-to-search function. The electronic device 101 may display a first interface that can perform a web search again for the image of the recognized object, and may display a second interface that can provide a search result screen obtained at the time point at which the user executed the circle-to-search function.

According to an embodiment, the electronic device 101 may display a recognized object in a first area of the display based on a user input for the first interface, and may display a latest search result for the recognized object in a second area of the display.

According to an embodiment, the electronic device 101 may display a recognized object in a first area of the display based on a user input for the first interface, and may display a latest search result for the recognized object in a second area of the display.

According to an embodiment, the electronic device 101 may display an image of a search result obtained at the time point at which the image for the recognized object was stored in the memory based on a user input for the second interface, and may display information about the time point at which the image of the recognized object was stored in the memory, information about the location where the image was stored, and information about a link selected by the user from the displayed search result.

In one embodiment, the electronic device 101 may display a first interface capable of performing again a web search for the image of the recognized object, and a second interface capable of providing a search result screen obtained at a time point at which the user has executed the circle-to-search function. The electronic device 101 may display a search result screen obtained at a current time point based on a user input for the first interface, may display a search result screen obtained at a past time point at which the user executed the circle-to-search function based on a user input for the second interface, and may provide information on a trend change or a price change to the user by comparing and providing a search result obtained at the past time point and a search result of the current time point.

According to an embodiment, the electronic device 101 may provide an interface capable of classifying images of recognized objects by topic or the time at which the images were stored, and optionally deleting images that have not been edited or searched by the user for a predetermined period. The topic may include at least one of food, places, or types of things.

According to an embodiment, the electronic device 101 may maintain images stored at a time point that has not passed a predetermined period from the stored time point, and may merge images having an identical classified topic among images stored at a time point that has passed the predetermined period from the stored time point and delete the individual images.

According to an embodiment, the electronic device 101 may determine that a captured image is an image related to the circle-to-search function, based on that a capture function is performed within a predetermined time after the circle-to-search function is performed, and may automatically store the image related to the circle-to-search function without any separate user input.

According to an embodiment, the electronic device 101 may be controlled to display an interface related to execution of the capture function, based on that a function of automatically storing the image related to the circle-to-search function is released, and in case that a user input for the interface related to execution of the capture function is not detected, be prevented from storing the image related to the circle-to-search function. The electronic device 101 may store the image related to the circle-to-search function in the memory in case that the user input for the interface related to execution of the capture function is detected, and may capture a screen for a search result of the image related to the circle-to-search function and store the screen in the memory.

According to an embodiment, the electronic device 101 may identify whether the circle-to-search function is in an activated state, identify whether a user input for an area to perform a search is detected, based on that the circle-to-search function is in the activated state, extract an image within the area to perform the search to recognize an object, based on that the user input for the area to perform the search is detected, and display a search result for the recognized object. The electronic device 101 may identify whether there is a folder related to the circle-to-search function in an image storage space of the electronic device, store the extracted image in the folder, based on that there is the folder related to the circle-to-search function, and store the extracted image and/or a search result screen for the object within the image in a folder related to a screenshot, based on that a user input related to capturing is detected.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
memory storing instructions and comprising one or more storage media; and
at least one processor comprising processing circuitry, the at least one processor communicatively coupled to the memory,
wherein the instructions, when individually or collectively executed by the at least one processor, cause the electronic device to:
activate a search function comprising a circle-to-search function, based on a configuration of the electronic device,
after the search function is activated, determine an area in which an object is to be recognized, based on a user input for a display,
recognize an object displayed within the determined area,
display the recognized object in a first area of the display,
display a search result of the recognized object in a second area of the display, and
store an image of the recognized object and information on the search result of the recognized object in a predetermined space of the memory, and
wherein the circle-to-search function comprises a function of designating a specific area in the display, based on an input of a user, and performing a search for an image of the determined area.

2. The electronic device of claim 1, wherein the instructions, when individually or collectively executed by the at least one processor, further cause the electronic device to:
in case that the circle-to-search function is executed, automatically store the image of the recognized object in the memory;
display the image of the recognized object and display together a time point at which the image of the recognized object is stored, a location at which the image is stored, and whether the image is an image searched for through the circle-to-search function;
display a first interface capable of performing again a web search for the image of the recognized object; and
display a second interface capable of providing a search result screen at a time point at which the user executes the circle-to-search function.

3. The electronic device of claim 2, wherein the instructions, when individually or collectively executed by the at least one processor, further cause the electronic device to:
display the recognized object in the first area of the display, based on the user input for the first interface; and
display a latest search result of the recognized object in the second area of the display.

4. The electronic device of claim 2, wherein the instructions, when individually or collectively executed by the at least one processor, further cause the electronic device to:
display an image for a search result at a time point at which the image of the recognized object is stored in the memory, based on the user input for the second interface; and
display information on the time point at which the image of the recognized object is stored in the memory, information on a location at which the image is stored, and information on a link selected by the user from the displayed search result.

5. The electronic device of claim 1, wherein the instructions, when individually or collectively executed by the at least one processor, further cause the electronic device to:
display a first interface capable of performing again a web search for the image of the recognized object;
display a second interface capable of providing a search result screen at a time point at which the user executes the circle-to-search function;
display a search result screen at a current time point, based on a user input for the first interface;
display a search result screen at a past time point at which the user executes the circle-to-search function, based on a user input for the second interface; and
provide information on a trend change or a price change to the user by comparing and providing a search result at the past time point and a search result of the current time point.

6. The electronic device of claim 1,
wherein the instructions, when individually or collectively executed by the at least one processor, further cause the electronic device to:
classify the image of the recognized object according to a stored time or a topic, and
provide an interface capable of selectively deleting images that are not edited for a predetermined period or are not searched for by the user, and
wherein the topic comprises at least one of types of food, places, or things.

7. The electronic device of claim 6, wherein the instructions, when individually or collectively executed by the at least one processor, further cause the electronic device to:
maintain images stored at a time point that has not passed a predetermined period from the time point;
merge images having an identical classified topic among images stored at a time point that has passed the predetermined period from the time point; and
delete individual images.

8. The electronic device of claim 1, wherein the instructions, when individually or collectively executed by the at least one processor, further cause the electronic device to:
determine that a captured image is an image related to the circle-to-search function, based on that a capture function is performed within a predetermined time after the circle-to-search function is performed; and
automatically store the image related to the circle-to-search function without any separate user input.

9. The electronic device of claim 8, wherein the instructions, when individually or collectively executed by the at least one processor, further cause the electronic device to:
display an interface related to execution of the capture function, based on that a function of automatically storing the image related to the circle-to-search function is released;
in case that a user input for the interface related to execution of the capture function is not detected, not store the image related to the circle-to-search function;
in case that the user input for the interface related to execution of the capture function is detected, store the image related to the circle-to-search function in the memory; and
capture a screen for a search result of the image related to the circle-to-search function and store the screen in the memory.

10. The electronic device of claim 1, wherein the instructions, when individually or collectively executed by the at least one processor, further cause the electronic device to:
identify whether the circle-to-search function is in an activated state;
identify whether a user input for an area to perform a search is detected, based on that the circle-to-search function is in the activated state;
extract an image within the area to perform the search to recognize an object, based on that the user input for the area to perform the search is detected, and display a search result for the recognized object;
identify whether there is a folder related to the circle-to-search function in an image storage space of the electronic device;
store the extracted image in the folder, based on that there is the folder related to the circle-to-search function; and
store the extracted image and a search result screen for the object within the image in a folder related to a screenshot, based on that a user input related to capturing is detected.

11. A method performed by an electronic device, the method comprising:
activating a search function comprising a circle-to-search function, based on a configuration of the electronic device;
after the search function is activated, determining an area in which an object is to be recognized, based on a user input for a display;
recognizing an object displayed within the determined area and displaying the recognized object in a first area of the display;
displaying a search result of the recognized object in a second area of the display; and
storing an image of the recognized object and/or information on the search result of the recognized object in a predetermined space of memory of the electronic device,
wherein the circle-to-search function comprises a function of designating a specific area in the display, based on an input of a user, and performing a search for an image in the determined area.

12. The method of claim 11, wherein the recognizing of the object displayed within the determined area comprises recognizing the object in a determined area of a video playing on the display based on the user input.

13. The method of claim 11, further comprising:
in case that the circle-to-search function is executed, automatically storing the image of the recognized object in the memory;
displaying the image of the recognized object and displaying together a time point at which the image of the recognized object is stored, a location at which the image is stored, and whether the image is an image searched for through the circle-to-search function; and
displaying a first interface capable of performing again a web search for the image of the recognized object and displaying a second interface capable of providing a search result screen for a search result obtained at a time point at which the user executes the circle-to-search function.

14. The method of claim 13, further comprising:
displaying the recognized object in the first area of the display, based on the user input for the first interface; and
displaying a latest search result of the recognized object in the second area of the display.

15. The method of claim 13, further comprising:
displaying an image for a search result obtained at a time point at which the image of the recognized object is stored in the memory, based on the user input for the second interface; and
displaying information on the time point at which the image of the recognized object is stored in the memory, information on a location at which the image is stored, and information on a link selected by the user from the displayed search result.

16. The method of claim 15, further comprising displaying a storage path of the image along with the image.

17. The method of claim 11, further comprising:
displaying a first interface capable of performing again a web search for the image of the recognized object and displaying a second interface capable of providing a search result screen obtained at a time point at which the user executes the circle-to-search function;
displaying a search result screen obtained at a current time point, based on a user input for the first interface;
displaying a search result screen for a search result obtained at a past time point at which the user executes the circle-to-search function, based on a user input for the second interface; and
providing information on a trend change or a price change to the user by comparing and providing a search result obtained at the past time point and a search result of the current time point.

18. The method of claim 11, further comprising:
classifying the image of the recognized object according to a stored time or a topic; and
providing an interface capable of selectively deleting images that are not searched for by the user or are not edited for a predetermined period,
wherein the topic comprises at least one of food, places, or types of things.

19. The method of claim 18, further comprising:
maintaining images stored at a time point that has not passed a predetermined period from the time point; and
merging images having an identical classified topic among images stored at a time point that has passed the predetermined period from the time point and deleting individual images.

20. The method of claim 11, further comprising:
determine that a captured image is an image related to the circle-to-search function, based on that a capture function is performed within a predetermined time after the circle-to-search function is performed;
automatically storing the image related to the circle-to-search function without any separate user input;
displaying an interface related to execution of the capture function, based on that a function of automatically storing the image related to the circle-to-search function is released;
in case that a user input for the interface related to execution of the capture function is not detected, performing a control to omit to store the image related to the circle-to-search function;
in case that the user input for the interface related to execution of the capture function is detected, storing the image related to the circle-to-search function in the memory; and
capturing a screen for a search result of the image related to the circle-to-search function and storing the screen in the memory.

21. The method of claim 11, further comprising:
identifying whether the circle-to-search function is in an activated state and identifying whether a user input for an area to perform a search is detected, based on that the circle-to-search function is in the activated state;
extracting an image within the area to perform the search to recognize an object, based on that the user input for the area to perform the search is detected, and displaying a search result for the recognized object;
identifying whether there is a folder related to the circle-to-search function in an image storage space of the electronic device and storing the extracted image in the folder, based on that there is the folder related to the circle-to-search function; and
storing the extracted image and a search result screen for the object within the image in a folder related to a screenshot, based on that a user input related to capturing is detected.

22. The method of claim 21, further comprising:
based on identifying that there is no folder related to the circle-to-search function in image storage space of the electronic device, creating a folder to store images used in the circle-to-search function.

23. A computer-readable non-transitory storage medium configured to store one or more programs comprising instructions that, when executed by at least one processor of an electronic device individually or collectively, cause the electronic device to:
activate a search function comprising a circle-to-search function, based on a configuration of the electronic device;
after the search function is activated, determine an area in which an object is to be recognized, based on a user input for a display;
recognize an object displayed within the determined area;
display the recognized object in a first area of the display;
display a search result of the recognized object in a second area of the display; and
store an image of the recognized object and/or information on the search result of the recognized object in a predetermined space of memory of the electronic device,
wherein the circle-to-search function comprises a function of designating a specific area in the display, based on a user input, and performing a search for an image in the determined area.
